(19) United States
(12) Patent Application Publication
(10) Pub. No.: US 2019/0287185 A1
(43) Pub. Date: Sep. 19, 2019

(54) Systems and Methods for Dynamically Generating a Customized Profile for a Person Based on a Travel-Related Behavior Pattern

(71) Applicant: TWIP Corp., Sunnyside, NY (US)

(72) Inventors: Serene Heather Richardson Wilde, Las Vegas, NV (US); Lauren A. Koenig, New York, NY (US)

(21) Appl. No.: 16/357,063

(22) Filed: Mar. 18, 2019

Related U.S. Application Data
(60) Provisional application No. 62/644,380, filed on Mar. 16, 2018.

(51) Int. Cl. G06Q 50/00; H04L 29/08; G06Q 30/02

(52) U.S. Cl. CPC G06Q 50/01; G06Q 30/0261; G06Q 30/0255; H04L 67/306

(57) ABSTRACT

Here presented are systems and methods for dynamically generating a user profile based on a travel-related behavior pattern, including a set of attribute types, with a customized attribute range. Implementations may be configured to create an initial model of a user by analyzing and recording their interactions with other users in a social network to update and adjust that initial model; adapted to receive a predefined profile corresponding to their selected profile type and aligned with user information corresponding to the unique identification information of profiles retrieved from the database. This will be collected over a period of time through population of data such as travel characteristics, personality traits and behaviors, influencing factors, and time and location information, in order to generate statistical information, adapt a profile for calculating determined attribute ranges for each of the set of attribute types and store generated customized ranges in custom profiles.

### RELATED APPLICATIONS

The subject matter of this application is related to U.S. Provisional Application No. 62/644,380, filed on 2018 Mar. 16, which is hereby incorporated by reference in its entirety.

### BACKGROUND OF THE INVENTION

With the rapid development of the travel-tourism market, more and more travelers choose to purchase travel through social computing methods, but for passenger travel destination, prediction techniques are currently underserved in the solo travel sector. The main problem is that the industry has been basing recommendations on time, destination and price, which mean the overall accuracy of the result is not satisfactory. This decreases the likelihood of purchase, or return visit.

In order to computationally predict consumer desirability, there is a need for a technology to be applied to predict passenger destinations and experiences in the field of tourism.

### SUMMARY OF THE INVENTION

The present disclosure relates to systems and methods for dynamically generating a customized profile for a person for based on a travel-related behavior pattern, the customized profile including a set of attribute types, each of the attribute types having a customized attribute range, the social computing system.

One aspect of the present disclosure relates to a system configured for dynamically generating a customized profile for a person for based on a travel-related behavior pattern, the customized profile including a set of attribute types, each of the attribute types having a customized attribute range, the social computing system. The system may include one or more hardware processors configured by machine-readable instructions. The processor(s) may be configured to configure the model to create an initial model of a user. The processor(s) may be configured to enhance the model to analyze and record interactions of the user with other users in a social network to update and adjust the initial model to provide an enhanced model for the user. An interaction module configured to permit interaction between user by may employ one of the initial model and the enhanced model. The processor(s) may be configured to adapt the receipt module for receiving a predefined profile corresponding to the selected profile type. The predefined profile may have predefined attribute types corresponding to the set of attribute types. Each of the predefined attribute types may have a predefined attribute range representing a range of attribute values for the selected profile type, with assessments having questions related to one or more attributes of the set of attribute types. Each of the questions may have a value assigned by the respective related individual. The processor(s) may be configured to align the information module for user information corresponding to the unique identification information of the profiles retrieved from the database, collected over a period of time the population from the user information and social statistics properties in travel characteristics, personality traits and behaviors influencing factors extracted by the attributes, and time and location information, generating a statistical information. The processor(s) may be configured to adapt a profile module for calculating determined attribute ranges for each of the attribute types of the set of attribute types based on the values of the questions. Adapted for may generate customized attribute ranges as a combination of the determined attribute ranges with the predefined attribute ranges. The processor(s) may be configured to store generated customized ranges as the customized profile in an output module.

Another aspect of the present disclosure relates to a method for dynamically generating a customized profile for a person for based on a travel-related behavior pattern, the customized profile including a set of attribute types, each of the attribute types having a customized attribute range, the social computing system. The method may include configuring the model to create an initial model of a user. The method may include enhancing the model to analyze and record interactions of the user with other users in a social network to update and adjust the initial model to provide an enhanced model for the user. An interaction module configured to permit interaction between user by may employ one of the initial model and the enhanced model. The method may include adapting the receipt module for receiving a predefined profile corresponding to the selected profile type. The predefined profile may have predefined attribute types corresponding to the set of attribute types. Each of the predefined attribute types may have a predefined attribute range representing a range of attribute values for the selected profile type, with assessments having questions related to one or more attributes of the set of attribute types. Each of the questions may have a value assigned by the respective related individual. The method may include aligning the information module for user information corresponding to the unique identification information of the profiles retrieved from the database, collected over a period of time the population from the user information and social statistics properties in travel characteristics, personality traits and behaviors influencing factors extracted by the attributes, and time and location information, generating a statistical information. The method may include adapting a profile module for calculating determined attribute ranges for each of the attribute types of the set of attribute types based on the values of the questions. Adapted for may generate customized attribute ranges as a combination of the determined attribute ranges with the predefined attribute ranges. The method may include storing generated customized ranges as the customized profile in an output module.

Yet another aspect of the present disclosure relates to a non-transient computer-readable storage medium having instructions embodied thereon, the instructions being executable by one or more processors to perform a method for dynamically generating a customized profile for a person for based on a travel-related behavior pattern, the customized profile including a set of attribute types, each of the attribute types having a customized attribute range, the social computing system. The method may include configuring the model to create an initial model of a user. The method may include enhancing the model to analyze and record interactions of the user with other users in a social network to update and adjust the initial model to provide an enhanced model for the user. An interaction module configured to permit interaction between user by may employ one of the initial model and the enhanced model. The method may include adapting the receipt module for receiving a predefined profile corresponding to the selected profile type. The predefined profile may have predefined attribute types corresponding to the set of attribute types. Each of the predefined attribute types may have a predefined attribute range representing a range of attribute values for the selected profile type, with assessments having questions related to one or more attributes of the set of attribute types. Each of the questions may have a value assigned by the respective related individual. The method may include aligning the information module for user information corresponding to the unique identification information of the profiles retrieved from the database, collected over a period of time the population from the user information and social statistics properties in travel characteristics, personality traits and behaviors influencing factors extracted by the attributes, and time and location information, generating a statistical information. The method may include adapting a profile module for calculating determined attribute ranges for each of the attribute types of the set of attribute types based on the values of the questions. Adapted for may generate customized attribute ranges as a combination of the determined attribute ranges with the predefined attribute ranges. The method may include storing generated customized ranges as the customized profile in an output module.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured for dynamically generating a customized profile for a person for based on a travel-related behavior pattern.

FIG. 2 illustrates a method for dynamically generating a customized profile for a person for based on a travel-related behavior pattern.

### DETAILED DESCRIPTION

In the following description, references are made to various embodiments in accordance with which the disclosed subject matter can be practiced. Some embodiments may be described using the expressions one/an/another embodiment or the like, multiple instances of which do not necessarily refer to the same embodiment. Particular features, structures or characteristics associated with such instances can be combined in any suitable manner in various embodiments unless otherwise noted.

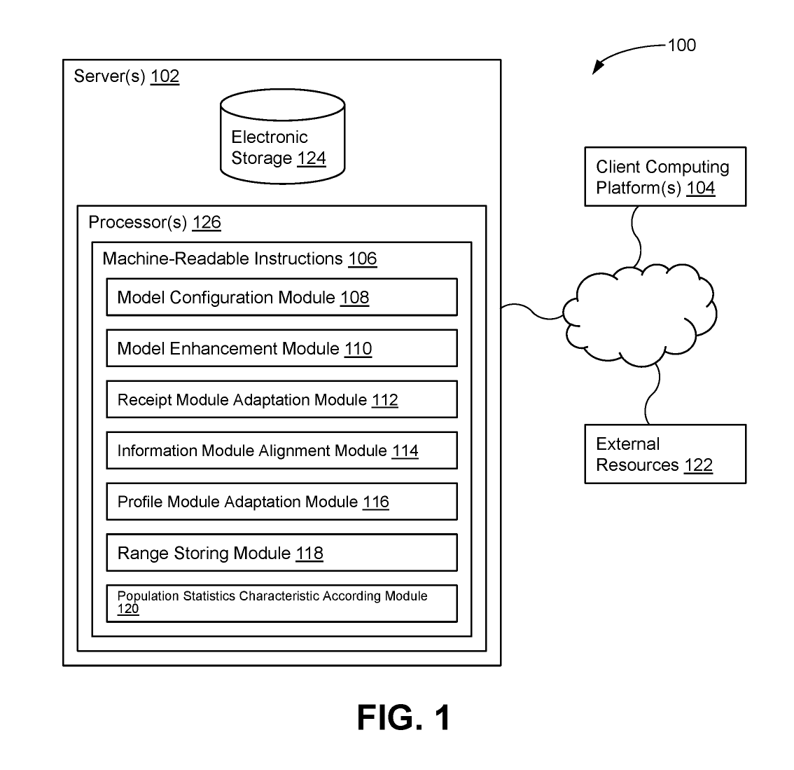

FIG. 1 illustrates a system 100 configured for dynamically generating a customized profile for a person for based on a travel-related behavior pattern, the customized profile including a set of attribute types, each of the attribute types having a customized attribute range, the social computing system, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of a model configuration module 108, a model enhancement module 110, a receipt module adaptation module 112, an information module alignment module 114, a profile module adaptation module 116, a range storing module 118, a population statistics characteristic according module 120, and/or other instruction modules.

Model configuration module 108 may be configured to configure the model to create an initial model of a user. The initial model may include a model that is occurring at the beginning, according to some implementations. The initial model may be created based on a questionnaire of a user's personality.

The questionnaire may be a form. The questionnaire may include a form containing a set of questions; submitted to people to gain statistical information, according to some implementations. Examples of the questionnaire may include one or more of personality inventory and/or other questionnaires. The personality may be an attribute. The personality may include the complex of all the attributes—behavioral, temperamental, emotional and mental—that characterize a unique individual, according to some implementations. Examples of the personality may include one or more of anal personality, genital personality, identity, narcissistic personality, obsessive-compulsive personality, oral personality, personableness, and/or other personalities.

Model enhancement module 110 may be configured to enhance the model to analyze and record interactions of the user with other users in a social network to update and adjust the initial model to provide an enhanced model for the user. The social network may include a network that is relating to human society and its members, according to some implementations. The enhanced model may include a model that is enhanced. To be enhanced may include being increased, according to some implementations.

At least one of the initial model and the enhanced model may be created from or augmented by direct input from other users. The direct input may include an input that is direct in spatial dimensions; proceeding without deviation or interruption; straight and short, according to some implementations. At least one of the initial model and the enhanced model may be created from or augmented by using a world personality model that describes a personality of a group of users. An interaction module configured to permit interaction between user by may employ one of the initial model and the enhanced model.

The initial model may be created by recording and analyzing the user's interaction with other users in the social network. The interaction module may calculate a personality match score between at least two models of users in the social network indicating closeness based on one or more criteria. The closeness may be a belonging. The closeness may include a feeling of being intimate and belonging together, according to some implementations. Examples of the closeness may include one or more of togetherness and/or other closeness. A given criterion may be a system of measurement. The criterion may include a basis for comparison; a reference point against which other things can be evaluated, according to some implementations. Examples of the criterion may include one or more of baseline, benchmark, earned run average, gauge, grade point average, medium of exchange, norm, procrustean standard, scale, yardstick, and/or other criteria.

The personality match score may be calculated for a specific predefined type of relationship. The interaction may module groups users by personality types. The interaction may module groups users by personality types.

Receipt module adaptation module 112 may be configured to adapt the receipt module for receiving a predefined profile corresponding to the selected profile type. The predefined profile may have predefined attribute types corresponding to the set of attribute types. Each of the predefined attribute types may have a predefined attribute range representing a range of attribute values for the selected profile type, with assessments having questions related to one or more attributes of the set of attribute types. A given assessment may be a classification. The assessment may include the classification of someone or something with respect to its worth, according to some implementations. Examples of the assessment may include one or more of acid test, assay, critical appraisal, evaluation, reappraisal, undervaluation, and/or other assessments.

A given question may be a questioning. The question may include an instance of questioning, according to some implementations. Each of the questions may have a value assigned by the respective related individual.

Information module alignment module 114 may be configured to align the information module for user information corresponding to the unique identification information of the profiles retrieved from the database, collected over a period of time the population from the user information and social statistics properties in travel characteristics, personality traits and behaviors influencing factors extracted by the attributes, and time and location information, generating a statistical information. The database may be an information. The database may include an organized body of related information, according to some implementations. Examples of the database may include one or more of electronic database, list, subdatabase, and/or other databases. A given behavior may be an activity. The behavior may include manner of acting or controlling yourself, according to some implementations. Examples of the behavior may include one or more of aggression, bohemianism, dirty pool, dirty tricks, discourtesy, easiness, the way of the world, and/or other behaviors.

A given factor may be a cause. The factor may include anything that contributes causally to a result, according to some implementations. Examples of the factor may include one or more of fundamental, intrinsic factor, parameter, releasing factor, unknown quantity, wild card, and/or other factors. The statistical information may include an information that is of or relating to statistics, according to some implementations.

Profile module adaptation module 116 may be configured to adapt a profile module for calculating determined attribute ranges for each of the attribute types of the set of attribute types based on the values of the questions. Adapted for may generate customized attribute ranges as a combination of the determined attribute ranges with the predefined attribute ranges. The customized attribute may include an attribute that is customized. To be customized may include being made to specifications, according to some implementations.

The combination may be a weighted combination of the determined attribute ranges and the predefined attribute ranges. The weighted combination may include a combination that is weighted. To be weighted may include being made heavy or weighted down with weariness, according to some implementations.

Range storing module 118 may be configured to store generated customized ranges as the customized profile in an output module. The customized profile may include a profile that is customized. To be customized may include being made to specifications, according to some implementations. The customized profile may be one of a plurality of customized profiles stored in a memory.

Population statistics characteristic according module 120 may be configured to of the prediction of tourism behavioral patterns according to the population and social statistics characteristics, travel characteristics, personality traits and behavioral factors. The behavioral factor may include a factor that is of or relating to behavior, according to some implementations. By way of non-limiting example, characteristics such as gender, age, nationality, occupation, marriage, income, education, and the trip characteristics may be accompanied by type, number of partners, travel form, visit status, visit including a number of travel periods, residence and destination between and one or more of the personality traits such as openness to experience, integrity, extroversion, friendliness, neurotic tendencies and other behavioral characteristics are influencing factors to the tourist behavior pattern prediction method.

The nationality may be a people. The nationality may include people having common origins or traditions and often comprising a nation, according to some implementations. The occupation may be an activity. The occupation may include the principal activity in your life that you do to earn money, according to some implementations. Examples of the occupation may include one or more of accountancy, appointment, career, catering, confectionery, employment, farming, game, métier, photography, position, profession, sport, trade, treadmill, and/or other occupations.

The income may be a financial gain. The income may include the financial gain accruing over a given period of time, according to some implementations. Examples of the income may include one or more of cash flow, disposable income, double dipping, easy money, ebitda, government income, gross sales, net income, net sales, per capita income, personal income, rental income, return, unearned income, unearned income, and/or other incomes. A given partner may be a domestic partner. The partner may include a person's partner in marriage, according to some implementations. Examples of the partner may include one or more of bigamist, consort, helpmate, husband, monogamist, newlywed, polygamist, wife, and/or other partners.

The residence may be an address. The residence may include any address at which you dwell more than temporarily, according to some implementations. Examples of the residence may include one or more of domicile, home, and/or other residences. The openness may be a spacing. The openness may include without obstructions to passage or view, according to some implementations. Examples of the openness may include one or more of patency and/or other openness.

The integrity may be a state. The integrity may include an undivided or unbroken completeness or totality with nothing wanting, according to some implementations. Examples of the integrity may include one or more of completeness, incompleteness, and/or other integrities. The extroversion may be a sociability. The extroversion may include an extroverted disposition; concern with what is outside the self, according to some implementations. Examples of the extroversion may include one or more of outwardness and/or other extroversions.

The friendliness may be a liking. The friendliness may include a feeling of liking for another person; enjoyment in their company, according to some implementations. Examples of the friendliness may include one or more of amicability, brotherhood, good will, and/or other friendliness. The neurotic tendency may include a tendency that is characteristic of or affected by neurosis, according to some implementations. The tendency may be an attitude. The tendency may include an attitude of mind especially one that favors one alternative over others, according to some implementations. Examples of the tendency may include one or more of bent, call, denominationalism, devices, direction, disfavor, drift, favor, favoritism, impartiality, literalism, partiality, perseveration, predisposition, proclivity, sympathy, and/or other tendencies.

The personality characteristics and behavioral factors may affect each property details are tourist behavior pattern prediction method, which is set based on the preset score of information. The preset score may include a score that is set in advance, according to some implementations.

In some implementations, where a personality type may be a descriptor of the user personality based on the personality test assessment methods. The descriptor may be an information. The descriptor may include a piece of stored information that is used to identify an item in an information storage and retrieval system, according to some implementations. In some implementations, where a personality type may be a descriptor of the user personality based on input from other users.

In some implementations, the profile may produce marketing recommendations using travel-related behavior pattern prediction model of consumers. A given consumer may be a user. The consumer may include a person who uses goods or services, according to some implementations. Examples of the consumer may include one or more of chewer, concert-goer, customer, drinker, drinker, eater, prodigal, smoker, snuffer, and/or other consumers.

In some implementations, server(s) 102, client computing platform(s) 104, and/or external resources 122 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 122 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 122, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 122 may include sources of information outside of system 100, external entities participating with system 100, and/or other resources. In some implementations, some or all of the functionality attributed herein to external resources 122 may be provided by resources included in system 100.

Server(s) 102 may include electronic storage 124, one or more processors 126, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 124 may comprise non-transitory storage media that electronically stores information. The electronic storage media of electronic storage 124 may include one or both of system storage that is provided integrally (i.e., substantially non-removable) with server(s) 102 and/or removable storage that is removabley connectable to server(s) 102 via, for example, a port (e.g., a USB port, a firewire port, etc.) or a drive (e.g., a disk drive, etc.). Electronic storage 124 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 124 may include one or more virtual storage resources (e.g., cloud storage, a virtual private network, and/or other virtual storage resources). Electronic storage 124 may store software algorithms, information determined by processor(s) 126, information received from server(s) 102, information received from client computing platform(s) 104, and/or other information that enables server(s) 102 to function as described herein.

Processor(s) 126 may be configured to provide information processing capabilities in server(s) 102. As such, processor(s) 126 may include one or more of a digital processor, an analog processor, a digital circuit designed to process information, an analog circuit designed to process information, a state machine, and/or other mechanisms for electronically processing information. Although processor(s) 126 is shown in FIG. 1 as a single entity, this is for illustrative purposes only. In some implementations, processor(s) 126 may include a plurality of processing units. These processing units may be physically located within the same device, or processor(s) 126 may represent processing functionality of a plurality of devices operating in coordination. Processor(s) 126 may be configured to execute modules 108, 110, 112, 114, 116, 118, 120, and/or other modules. Processor(s) 126 may be configured to execute modules 108, 110, 112, 114, 116, 118, 120, and/or other modules by software; hardware; firmware; some combination of software, hardware, and/or firmware; and/or other mechanisms for configuring processing capabilities on processor(s) 126. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, and 120 are illustrated in FIG. 1 as being implemented within a single processing unit, in implementations in which processor(s) 126 includes multiple processing units, one or more of modules 108, 110, 112, 114, 116, 118, and/or 120 may be implemented remotely from the other modules. The description of the functionality provided by the different modules 108, 110, 112, 114, 116, 118, and/or 120 described below is for illustrative purposes, and is not intended to be limiting, as any of modules 108, 110, 112, 114, 116, 118, and/or 120 may provide more or less functionality than is described. For example, one or more of modules 108, 110, 112, 114, 116, 118, and/or 120 may be eliminated, and some or all of its functionality may be provided by other ones of modules 108, 110, 112, 114, 116, 118, and/or 120. As another example, processor(s) 126 may be configured to execute one or more additional modules that may perform some or all of the functionality attributed below to one of modules 108, 110, 112, 114, 116, 118, and/or 120.

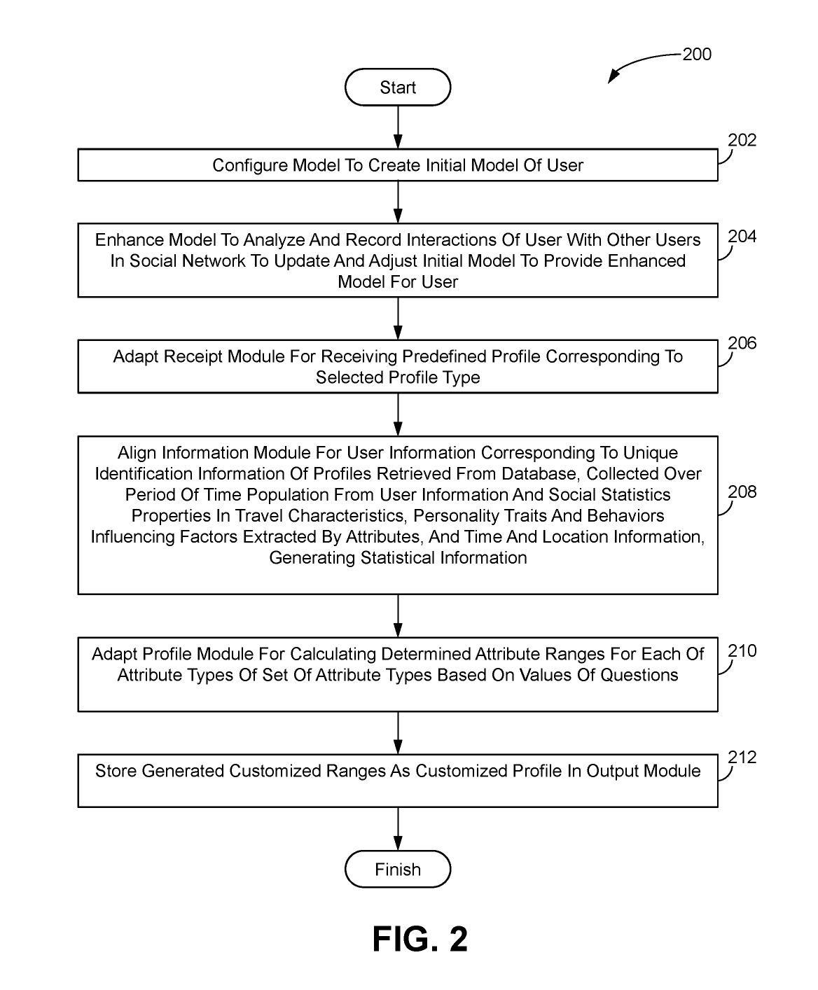

FIG. 2 illustrates a method 200 for dynamically generating a customized profile for a person for based on a travel-related behavior pattern, the customized profile including a set of attribute types, each of the attribute types having a customized attribute range, the social computing system, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include configuring the model to create an initial model of a user. Operation 202 may be performed by one or more hardware processors configured by machine-readable instructions including a module that is the same as or similar to model configuration module 108, in accordance with one or more implementations.

An operation 204 may include enhancing the model to analyze and record interactions of the user with other users in a social network to update and adjust the initial model to provide an enhanced model for the user. An interaction module configured to permit interaction between user by may employ one of the initial model and the enhanced model. Operation 204 may be performed by one or more hardware processors configured by machine-readable instructions including a module that is the same as or similar to model enhancement module 110, in accordance with one or more implementations.

An operation 206 may include adapting the receipt module for receiving a predefined profile corresponding to the selected profile type. The predefined profile may have predefined attribute types corresponding to the set of attribute types. Each of the predefined attribute types may have a predefined attribute range representing a range of attribute values for the selected profile type, with assessments having questions related to one or more attributes of the set of attribute types. Each of the questions may have a value assigned by the respective related individual. Operation 206 may be performed by one or more hardware processors configured by machine-readable instructions including a module that is the same as or similar to receipt module adaptation module 112, in accordance with one or more implementations.

An operation 208 may include aligning the information module for user information corresponding to the unique identification information of the profiles retrieved from the database, collected over a period of time the population from the user information and social statistics properties in travel characteristics, personality traits and behaviors influencing factors extracted by the attributes, and time and location information, generating a statistical information. Operation 208 may be performed by one or more hardware processors configured by machine-readable instructions including a module that is the same as or similar to information module alignment module 114, in accordance with one or more implementations.

An operation 210 may include adapting a profile module for calculating determined attribute ranges for each of the attribute types of the set of attribute types based on the values of the questions. Adapted for may generate customized attribute ranges as a combination of the determined attribute ranges with the predefined attribute ranges. Operation 210 may be performed by one or more hardware processors configured by machine-readable instructions including a module that is the same as or similar to profile module adaptation module 116, in accordance with one or more implementations.

An operation 212 may include storing generated customized ranges as the customized profile in an output module. Operation 212 may be performed by one or more hardware processors configured by machine-readable instructions including a module that is the same as or similar to range storing module 118, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured for dynamically generating a customized profile for a person for based on a travel-related behavior pattern, the customized profile including a set of attribute types, each of the attribute types having a customized attribute range, the social computing system, the system comprising:
one or more hardware processors configured by machine-readable instructions to:
configure the model to create an initial model of a user;
enhance the model to analyze and record interactions of the user with other users in a social network to update and adjust the initial model to provide an enhanced model for the user, an interaction module configured to permit interaction between user by employing one of the initial model and the enhanced model;
adapt the receipt module for receiving a predefined profile corresponding to the selected profile type, the predefined profile having predefined attribute types corresponding to the set of attribute types, each of the predefined attribute types having a predefined attribute range representing a range of attribute values for the selected profile type, with assessments having questions related to one or more attributes of the set of attribute types, each of the questions having a value assigned by the respective related individual;
align the information module for user information corresponding to the unique identification information of the profiles retrieved from the database, collected over a period of time the population from the user information and social statistics properties in travel characteristics, personality traits and behaviors influencing factors extracted by the attributes, and time and location information, generating a statistical information;
adapt a profile module for calculating determined attribute ranges for each of the attribute types of the set of attribute types based on the values of the questions, and adapted for generating customized attribute ranges as a combination of the determined attribute ranges with the predefined attribute ranges; and
store generated customized ranges as the customized profile in an output module.

2. The system of claim 1, wherein the initial model is created based on a profile comprising:
on a questionnaire of a user's personality;
recording and analyzing the user's interaction with other users in the social network;
direct input from other users;
a world personality model that describes a personality of a group of users; and
a calculated personality match score between at least two models of users in the social network indicating closeness based on one or more criteria.

3. The system of claim 2, wherein the personality match score is calculated for a specific predefined type of relationship.

4. The system of claim 1, wherein the interaction module groups users by personality types, where a personality type is a descriptor of the user personality based on:
the personality test assessment methods; and
input from other users.

5. The system of claim 1, wherein the combination is a weighted combination of the determined attribute ranges and the predefined attribute ranges.

6. The system of claim 2, wherein the customized profile is one of a plurality of customized profiles stored in a memory.

7. The system of claim 1, wherein the profile produces marketing recommendations using travel-related behavior pattern prediction model of consumers.

8. The system of claim 1, wherein the one or more hardware processors are further configured by machine-readable instructions to of the prediction of tourism behavioral patterns according to the population and social statistics characteristics, travel characteristics, personality traits and behavioral factors.

9. The system of claim 1, wherein characteristics such as gender, age, nationality, occupation, marriage, income, education, and the trip characteristics are accompanied by type, number of partners, travel form, visit status, visit including a number of travel periods, residence and destination between and one or more of the personality traits such as openness to experience, integrity, extroversion, friendliness, neurotic tendencies and other behavioral characteristics are influencing factors to the tourist behavior pattern prediction method.

10. The system of claim 9, wherein the personality characteristics and behavioral factors affect each property details are tourist behavior pattern prediction method, which is set based on the preset score of information.

11. A method for dynamically generating a customized profile for a person for based on a travel-related behavior pattern, the customized profile including a set of attribute types, each of the attribute types having a customized attribute range, the social computing system comprising:
configuring the model to create an initial model of a user;
enhancing the model to analyze and record interactions of the user with other users in a social network to update and adjust the initial model to provide an enhanced model for the user; and an interaction module configured to permit interaction between user by employing one of the initial model and the enhanced model;
adapting the receipt module for receiving a predefined profile corresponding to the selected profile type, the predefined profile having predefined attribute types corresponding to the set of attribute types, each of the predefined attribute types having a predefined attribute range representing a range of attribute values for the selected profile type, with assessments having questions related to one or more attributes of the set of attribute types, each of the questions having a value assigned by the respective related individual;
aligning the information module for user information corresponding to the unique identification information of the profiles retrieved from the database, collected over a period of time the population from the user information and social statistics properties in travel characteristics, personality traits and behaviors influencing factors extracted by the attributes, and time and location information, generating a statistical information;
adapting a profile module for calculating determined attribute ranges for each of the attribute types of the set of attribute types based on the values of the questions, and adapted for generating customized attribute ranges as a combination of the determined attribute ranges with the predefined attribute ranges; and
storing generated customized ranges as the customized profile in an output module.

12. The method of claim 11, wherein the initial model is created based on a profile comprising:
on a questionnaire of a user's personality;
recording and analyzing the user's interaction with other users in the social network;
direct input from other users;
a world personality model that describes a personality of a group of users; and
a calculated personality match score between at least two models of users in the social network indicating closeness based on one or more criteria.

13. The method of claim 12, wherein the personality match score is calculated for a specific predefined type of relationship.

14. The method of claim 11, wherein the interaction module groups users by personality types, where a personality type is a descriptor of the user personality based on:
the personality test assessment methods; and
input from other users.

15. The method of claim 11, wherein the combination is a weighted combination of the determined attribute ranges and the predefined attribute ranges.

16. The method of claim 15, wherein the customized profile is one of a plurality of customized profiles stored in a memory.

17. The method of claim 11, wherein the profile produces marketing recommendations using travel-related behavior pattern prediction model of consumers.

18. The method of claim 11, further comprising of the prediction of tourism behavioral patterns according to the population and social statistics characteristics, travel characteristics, personality traits and behavioral factors.

19. The method of claim 11, wherein characteristics such as gender, age, nationality, occupation, marriage, income, education, and the trip characteristics are accompanied by type, number of partners, travel form, visit status, visit including a number of travel periods, residence and destination between and one or more of the personality traits such as openness to experience, integrity, extroversion, friendliness, neurotic tendencies and other behavioral characteristics are influencing factors to the tourist behavior pattern prediction method.

20. The method of claim 19, wherein the personality characteristics and behavioral factors affect each property details are tourist behavior pattern prediction method, which is set based on the preset score of information.
